(19) United States
(12) Patent Application Publication
(10) Pub. No.: US 2019/0343713 A1
(43) Pub. Date: Nov. 14, 2019

(54) COMPARTMENTALIZED MASSAGE ROLLER

(71) Applicant: MPD Holdings, Inc., Cerritos, CA (US)

(72) Inventor: Glenn M. Boghosian, Cerritos, CA (US)

(73) Assignee: MPD Holdings, Inc., Cerritos, CA (US)

(21) Appl. No.: 15/976,513

(22) Filed: May 10, 2018

(51) Int. Cl. A61H 15/00

(52) U.S. Cl. CPC A61H 15/0092; A61H 2201/1692; A61H 2201/1253; A61H 2015/0014

(57) ABSTRACT

A compartmentalized massage roller is disclosed facilitating a unitary structure for separable components, and thus capable of providing a plurality of massage techniques. The massage roller can contain an outer sleeve and an inner roller, wherein the outer sleeve defines a hollow opening configured to receive and enclose the inner roller. The inner roller is removably secured to the outer sleeve through frictional forces exerted through contact between the inner roller and hollow opening surface. The outer sleeve can define a plurality of curvy ridges configured to target softer muscles. The inner roller can contain a plurality of inner ridges configured to mimic myofascial release therapy typically conducted by fingers. The inner ridges further define a plurality of troughs, each located between a pair of adjacent inner ridges, wherein the troughs are configured to encapsulate and secure muscles to release binding collagen. The outer sleeve and inner roller can be further constructed with ethyl-vinyl acetate, which can be configured with varying Shore Hardness Levels.

### FIELD OF THE INVENTION

The present invention relates generally to massage rollers and, more particularly, to a compartmentalized, separable massage roller for targeting specific muscle types.

### BACKGROUND OF THE INVENTION

Massage rollers have provided an alternative and convenient means to obtaining a traditional massage wherein a user can instead perform a self-massage at one's leisure. The process of self-massaging with a massage roller, or the technical term “self-myofascial release”, targets a type of therapy for the nerves and connective tissues of an individual. Benefits of self-myofascial release include correcting muscle imbalances, relieves muscles soreness and joint stress, and relaxes the muscles.

Massage rollers are interchangeably referred to as foam rollers which is due to the material such rollers are typically constructed with. Moreover, there are many types of massage roller designs, each providing the user with a specific purpose. Some examples may include a low-density foam roller, which provide a soft texture that is used for those muscles that may be particularly sore or tender. By contrast, a firm, higher-density foam roller can provide a more intense, deeper and concentrated massage, which is more beneficial to those stronger and larger muscles that require more pressure. Other types of massage rollers may include some sort of texture encompassing the surface of the roller, such as ridges and/or bumps, which are designed to provide specific points of pressure that can help release certain muscle knots more effectively.

Although massage rollers offer the flexibility of being used anywhere, they are typically associated with physical activity wherein the self-myofascial process is ideal to help muscles recover and reduce soreness after such physical activity, e.g. a fitness workout. As such, massage rollers are often transported to/from areas of physical activity, such as a gym or studio. Given that massage rollers are typically not large or bulky, transporting would not be considered a difficult task.

However, each massage roller is typically constructed with a uniform design throughout the respective roller, thereby offering a limited variation of the types of massages available to the user, and more specifically, limiting the types of muscles that can receive a targeted massage. As such, if one desires to apply different massaging techniques using a massage roller to specific muscles, an individual would be required to use a plurality of massage roller types. This imposes an inconvenient burden on an individual that would generally be required to transport several massage rollers to a gym or studio in order to achieve such targeted self-massaging.

It should, therefore, be appreciated that there exists a need for a compartmentalized massage roller that targets specific muscle types.

### SUMMARY OF THE INVENTION

Briefly, and in general terms, the invention provides a compartmentalized massage roller with separable components, wherein each component can be used to target a specific group of muscles and body parts. The separable components can include an outer sleeve, and an inner roller, wherein the outer sleeve can contain an inner, hollow opening for receiving the inner roller. As such, the massage roller can be transported as a unitary structure, thereby facilitating ease in transporting a massage roller that can target a plurality of groups of muscles.

More specifically, by example and not limitation, the surface of the outer sleeve consists of a plurality of curvy ridges that can be disposed about the circumference of the outer sleeve, each extending along the length of the massage roller. The outer sleeve surface can be made of any foaming polymer, including Ethyl-Vinyl Acetate (EVA), wherein the material can be specified to contain a hardness resembling that of rubber, but without the weight that accompanies with rubber. The hardness can be specified based on the Shore Hardness level, wherein a typical level for the outer sleeve is 40, but can range between 20-70. The outer sleeve design and hardness is configured to target the massaging of softer muscles, including arms and legs.

In another detailed aspect of an exemplary embodiment, the inner roller consists of a plurality of inner ridges disposed along the length of the inner roller, each circumscribing about a longitudinal axis of the inner roller. Moreover, the plurality of inner ridges define a plurality of troughs, wherein each trough is located between two adjacent inner ridges. The inner ridges can contain a shore hardness level higher than the outer sleeve ridges. The inner roller design and hardness level is configured to target massaging larger, stronger muscles, including the back muscles.

In yet another detailed aspect of an exemplary embodiment, the inner ridges can be sized with a width mimicking a finger width, so as to simulate myofascial release therapy on the muscles, which is typically conducted using fingers. Moreover, the troughs can be sized with a width roughly double the width of each inner ridge, and can be configured to encapsulate and secure one or more muscles so as to enable separation from binding collagen film that inhibits proper muscle function.

In yet another detailed aspect of an exemplary embodiment, the inner ridges are raised sufficiently to contact the surface of the hollow opening when the inner roll is inserted within the outer sleeve. As such, the inner roller provides structural support for the outer sleeve when inserted within. Moreover, the frictional forces exerted between the inner ridges and hollow opening surface, due to the contact, helps prevent the inner roller from readily sliding out of the outer sleeve. The frictional forces are further amplified by pressure exerted on the outer sleeve by a user when the massage roller is being held, such as when being transported, or when the massage roller is being used with the inner roller stored within the outer sleeve, thereby further securing the inner roller within the outer sleeve.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a front perspective view of a massage roller in accordance with the invention, depicting an inner roller nested within an outer sleeve.

FIG. 2 is a front perspective view of the massage roller in FIG. 1, depicting the inner roller as partially inserted within the outer sleeve.

FIG. 3 is a side view of the massage roller in FIG. 1, depicting the curvature of the ridges on the outer sleeve and a longitudinal axis defined by the outer sleeve.

FIG. 4 is a front perspective view of the massage roller in FIG. 1, depicting the outer sleeve without the inner roller inserted, and thereby exposing the inner, hollow opening of the outer sleeve.

FIG. 5 is a front view of the massage roller in FIG. 1, depicting the outer sleeve hollow opening without the inner roller inserted within.

FIG. 6 is a front view of the massage roller in FIG. 1, depicting the inner roller nested within the outer sleeve hollow opening.

FIG. 7 is a side, vertical view of an inner roller in accordance with the invention, depicting the inner roller ridge and trough patterned configuration, and depicting a longitudinal axis defined by the inner roller.

FIG. 8 is a side, horizontal view of the inner roller in FIG. 7, depicting an exemplary pair of adjacent ridges with a trough in between.

FIG. 9 is a front perspective view of the inner roller in FIG. 7, depicting the uniform dimensions of the ridge and troughs.

### DETAILED DESCRIPTION OF THE PREFERRED EMBODIMENTS

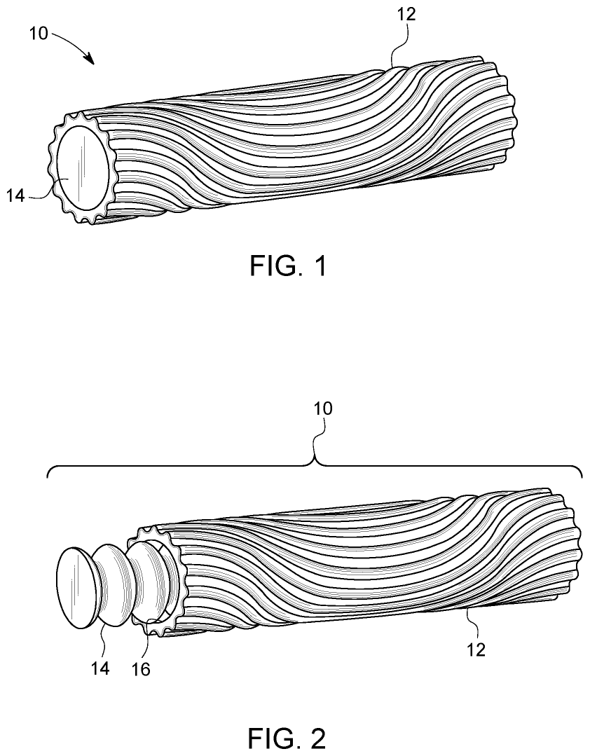

Referring now to the drawings, and particularly FIGS. 1 and 2, there is shown a compartmentalized massage roller 10 configured to provide a plurality of massage techniques for targeting a plurality of muscles. The massage roller 10 can contain an outer sleeve 12 that defines a hollow opening 16. The massage roller 10 can further contain a separable inner roller 14 that can be inserted within the hollow opening 16 of the outer sleeve 12. The outer sleeve 12 and inner roller 14 can differ in texture and density, thereby providing a massage roller 10 that can target multiple types of muscles, while facilitating ease in transportability due to a unitary structure storing configuration.

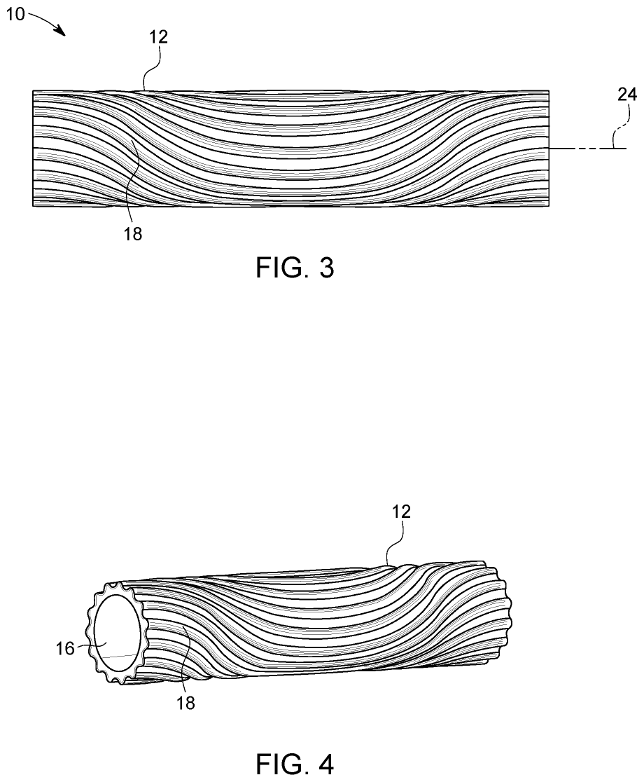

Referring now to FIGS. 3-4, the outer sleeve 12 can include an exterior surface that defines a plurality of curvy ridges 18, each extending across the length of the outer sleeve 12 as defined by its longitudinal axis 24. The curvy ridges 18 can be parallel with each other, and be disposed in a circumscribing manner about the outer sleeve 12 exterior surface. The outer sleeve 12 can be constructed with any foaming polymer. The exemplary embodiment depicts an outer sleeve 12 constructed with Ethylene-Vinyl Acetate (EVA), which provides a rubber-like texture, and further adapting a rubber-like hardness and flexibility. The use of EVA is more advantageous than using rubber itself, considering that using rubber would increase the weight of the massage roller 10, thereby providing a strain in its transportability. Moreover, EVA, through various commonly known foaming techniques, can be altered to feature a more resilient and rigid structure, i.e. higher shore hardness level, such that it can exhibit the dense-like features of rubber without the accompanying weight associated with rubber.

The outer sleeve 12 exterior surface is typically configured with a shore hardness level of 40, but the shore hardness level can vary for a given embodiment, wherein a lower shore hardness corresponds to a more softer texture, and is easily susceptible to indentation due to applied force. As designed, the curvy ridges 18 with the designated shore hardness levels are configured to target softer muscles, wherein the applied pressure points are distributed across the raised portion of the plurality of curvy ridges in contact with a user. Such muscles that can be targeted include arms and legs.

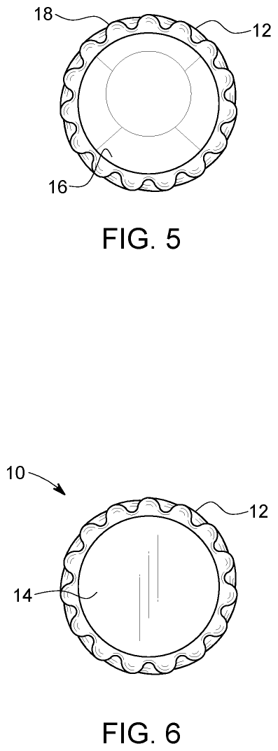

Referring now to FIG. 5, as aforementioned, the outer sleeve 12 defines an inner, hollow opening 16. The surface of the hollow opening can be smooth and uniform, and be constructed with the same material as the outer sleeve 12 exterior surface, which includes EVA.

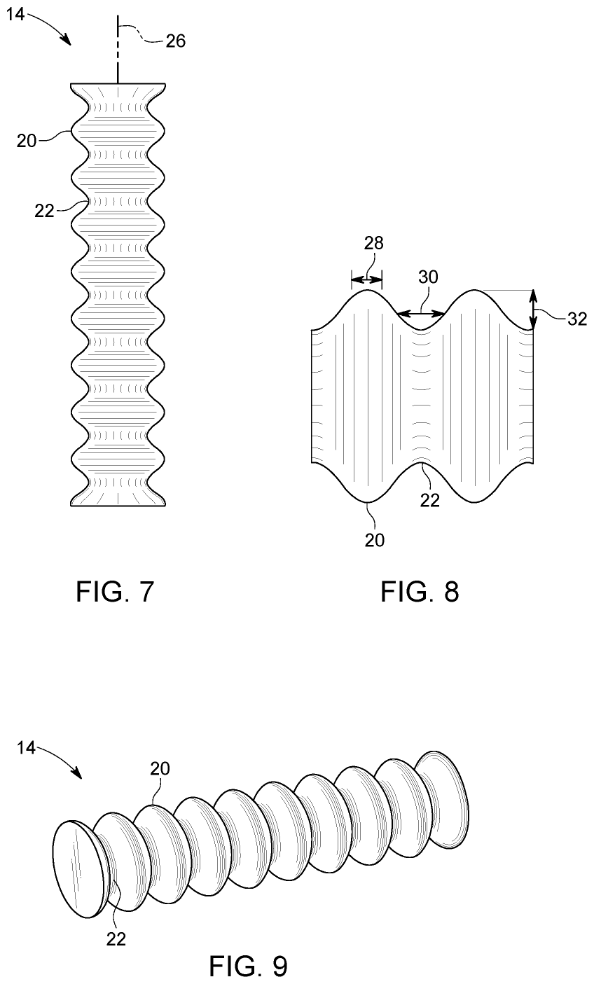

Referring now to FIGS. 7-9, the inner roller 14 includes an exterior surface containing a plurality of ridges 20 (“inner ridges”) that each circumscribe about an inner roller longitudinal axis 26. The inner ridges 20 are disposed along the length of the inner roller 14, as defined by the longitudinal axis 26, wherein each pair of adjacent ridges 20 defines a trough 22. The exemplary embodiment depicts an inner roller with 10 ridges and 9 troughs. As depicted in FIG. 8, the ridges 20 are sized with a width 28 that mimics a finger, thereby simulating myofascial release therapy, wherein the goal of myofascial therapy is to stretch and loosen the fascia so that it and other contiguous structures can move more freely, and the patient's motion is restored. For this reason, myofascial therapy is sometimes referred to as ‘myofascial release’ therapy. It may also be referred to as ‘myofascial trigger point therapy’ by others and helps release muscle spasms. The inner ridges can each be configured with a ridge width 28 ranging between 0.2 inches to 0.8 inches. The exemplary embodiment includes a ridge width 28 of approximately 0.4 inches. The troughs 22 are sized with a width 30 that can mimic two fingers, or a width that is double of the ridge width 28. The trough width 30 in combination with the trough depth 32 enables for muscle(s) to be encapsulated and secured in place, thereby allowing the muscle(s) to be separated from binding collagen film that inhibits proper muscle function. The troughs can each be configured with a trough width 30 ranging between 0.4 inches to 1.6 inches, while the trough depth 32 can range between 0.5 inches to 2 inches. The exemplary embodiment includes a trough width 30 of approximately 0.8 inches, and a trough depth 32 of approximately 1 inch.

The inner roller 14 can be constructed of the same material as the outer sleeve 12, which can include using EVA. However, the shore hardness specified for the inner roller 14 can be higher than that of the outer sleeve 12, with 50 being a typical shore hardness level. The circumscribing ridge design, the specified shore hardness level, and disposed ridges across the inner roller 14 length configures the inner roller 14 to target larger, stronger muscles, wherein the applied pressure points are more concentrated than the outer sleeve 12, considering there can be less surface area contact between the inner roller 14 and a given human body part. Larger, stronger muscles targeted by the inner roller 14 include the back muscles.

As such, the graduated hardness of the combination of the outer sleeve 12, the inner roller 14, and the troughs 22 of the inner roller can provide a series of hardness levels ranging from 20 to 70 within the same massage roller 10.

Referring now to FIGS. 1, and 5-6, as aforementioned, the outer sleeve hollow opening 16 is further configured to receive the inner roller 14 such that the inner roller 14 is nested within the outer sleeve 12. The diameter of each of the inner ridges 20 (FIGS. 7-9) is sized such that the edges of the inner ridges 20 are raised sufficiently to contact the hollow opening 16 surface (FIGS. 1 and 6) when inserted within the outer sleeve 12. As such, the inner roller provides structural support for the outer sleeve when inserted within. Moreover, the frictional forces exerted between the inner ridges 20 and hollow opening 16 surface help prevent the inner roller 14 from readily sliding out of the outer sleeve 12, even when the outer sleeve 12 is positioned vertically. The frictional forces exerted between the inner ridges 20 and hollow opening 16 surface are further amplified by pressure exerted on the outer sleeve 12 by a user when the massage roller 10 is being held, such as when being transported, or when the massage roller 10 is being used while the inner roller 14 is stored within the outer sleeve 12.

It should be appreciated from the foregoing that the present invention provides a compartmentalized massage roller facilitating a unitary structure for separable components and thus capable of providing a plurality of massage techniques. The massage roller can contain an outer sleeve and an inner roller, wherein the outer sleeve defines a hollow opening configured to receive and enclose the inner roller. The inner roller is removably secured to the outer sleeve through frictional forces exerted through contact between the inner roller and hollow opening surface. The outer sleeve can define a plurality of curvy ridges configured to target softer muscles. The inner roller can contain a plurality of inner ridges configured to mimic myofascial release therapy typically conducted by fingers. The inner ridges further define a plurality of troughs, each located between a pair of adjacent inner ridges, wherein the troughs are configured to encapsulate and secure muscles to release binding collagen. The outer sleeve and inner roller can be further constructed with ethyl-vinyl acetate, which can be configured with varying Shore Hardness Levels.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A compartmentalized massage roller, comprising:
an outer sleeve body comprising an external surface and an internal surface, the external surface defining a first plurality of ridges disposed in a circumscribing manner about the outer sleeve body, each ridge of the first plurality of ridges extending from a proximal end to a distal end of the outer sleeve body, the internal surface defining a hollow opening within the outer sleeve body, the hollow opening disposed along a first longitudinal axis defined between said proximal and distal ends of the outer sleeve body; and
an inner roller body removably coupled to the internal surface, the inner roller body defining a second longitudinal axis, wherein the inner roller body is configured to be inserted within the hollow opening, aligning the second longitudinal axis with the first longitudinal axis, the inner roller body defining a second plurality of ridges disposed along the second longitudinal axis, each ridge of the second plurality of ridges circumscribing about the second longitudinal axis.

2. The compartmentalized massage roller defined in claim 1, wherein the first plurality of ridges are disposed in parallel with each other.

3. The compartmentalized massage roller defined in claim 2, wherein each ridge of the first plurality of ridges defines a curved path while extending from the proximal end of the outer sleeve body to the distal end of the outer sleeve body.

4. The compartmentalized massage roller defined in claim 1, wherein the width of each ridge of the second plurality of ridges can range between 0.2 inches to 0.8 inches, so as to simulate finger-based myofascial release therapy on a user via contact with one or more ridges of the second plurality of ridges.

5. The compartmentalized massage roller defined in claim 4, wherein the inner roller body defines a plurality of troughs, each trough of the plurality of troughs disposed between a pair of adjacent ridges of the second plurality of ridges, each trough configured with a width ranging between 0.4 inches and 1.6 inches, each trough configured with a depth ranging between 0.5 inches and 2.0 inches, so as to enable one or more muscles of a user to be encapsulated and secured within a respective trough when one or more corresponding ridges of the second plurality of ridges are in contact with the user.

6. The compartmentalized massage roller defined in claim 5, wherein the second plurality of ridges comprises 10 ridges and defines 9 troughs.

7. The compartmentalized massage roller defined in claim 1, wherein the outer sleeve body and inner roller body are constructed with Ethyl-Vinyl Acetate (“EVA”).

8. The compartmentalized massage roller defined in claim 7, wherein the outer sleeve body, inner roller body, and troughs provide a graduated hardness texture, comprising of Shore Hardness Levels between 20-70.

9. The compartmentalized massage roller defined in claim 7, wherein the inner roller body is constructed with EVA comprising a Shore Hardness Level of 50.

10. The compartmentalized massage roller defined in claim 1, wherein the inner roller body is coupled to the internal surface via frictional forces exerted through contact between the second plurality of ridges and the internal surface.

11. The compartmentalized massage roller defined in claim 1, wherein the inner hollow opening contains a first open-end disposed on the proximal end of the outer sleeve body, and a second open-end disposed on the distal end of the outer sleeve body, enabling the inner roller body to be inserted and/or removed through either the first open-end and/or the second open-end.

12. A compartmentalized massage roller, comprising:
a tube defining an inner hollow compartment along a first longitudinal axis, the tube configured as a sleeve wherein the inner hollow compartment is disposed with a first open-end on a proximal end of the tube and a second open-end on a distal end of the tube; the tube comprising an internal surface circumscribing the inner hollow compartment;
an external surface enclosing the tube about the first longitudinal axis, the external surface defining a first plurality of ridges disposed in a circumscribing manner about the first longitudinal axis, each ridge of the first plurality of ridges extending from the proximal end of the tube to the distal end of the tube; and
a roller body removably coupled to the internal surface, the inner roller body defining a second longitudinal axis, wherein the roller body is configured to be inserted within the inner hollow compartment, aligning the second longitudinal axis with the first longitudinal axis, the roller body defining a second plurality of ridges disposed along the second longitudinal axis, wherein each ridge of the second plurality of ridges circumscribes about the second longitudinal axis, the roller body frictionally coupled to the internal surface via contact between the second plurality of ridges and the internal surface.

13. The compartmentalized massage roller defined in claim 12, wherein the external surface, the internal surface, and roller body are constructed with Ethyl-Vinyl Acetate (“EVA”).

14. The compartmentalized massage roller defined in claim 13, wherein the tube and roller body provide a graduated hardness texture, comprising of Shore Hardness Levels between 20-70.

15. The compartmentalized massage roller defined in claim 14, wherein the roller body is constructed with EVA comprising a Shore Hardness Level of 50.

16. The compartmentalized massage roller defined in claim 15, wherein the width of each ridge of the second plurality of ridges can range between 0.2 inches to 0.8 inches, so as to simulate finger-based myofascial release therapy on a user via contact with one or more ridges of the second plurality of ridges.

17. The compartmentalized massage roller defined in claim 16, wherein the roller body defines a plurality of troughs, each trough of the plurality of troughs disposed between a pair of adjacent ridges of the second plurality of ridges, each trough configured with a width ranging between 0.4 inches and 1.6 inches, each trough configured with a depth ranging between 0.5 inches and 2.0 inches, so as to enable one or more muscles of a user to be encapsulated and secured within a respective trough when one or more corresponding ridges of the second plurality of ridges are in contact with the user.

18. The compartmentalized massage roller defined in claim 17, wherein the second plurality of ridges comprises 10 ridges and defines 9 troughs.

19. The compartmentalized massage roller defined in claim 18, wherein the first plurality of ridges are disposed in parallel with each other.

20. The compartmentalized massage roller defined in claim 19, wherein each ridge of the first plurality of ridges defines a curved path while extending from the proximal end of the tube to the distal end of the tube.
